(19) United States
(12) Patent Application Publication
(10) Pub. No.: US 2025/0360689 A1
(43) Pub. Date: Nov. 27, 2025

(54) LAMINATED FABRIC HAVING GLOSSY SURFACE, MANUFACTURING METHOD THEREFOR AND EXTERIOR COVER PRODUCT USING LATENT IMAGE-PATTERNED FABRIC OBTAINED THEREFROM

(71) Applicants: Jong-Youb KIM, Yongin-si (KR); WOORIOPTO INC., Yongin-si (KR)

(72) Inventor: Jong-Youb KIM, Yongin-si (KR)

(21) Appl. No.: 19/295,685

(22) Filed: Aug. 10, 2025

Related U.S. Application Data
(63) Continuation of application No. PCT/KR2024/001330, filed on Jan. 29, 2024.

(30) Foreign Application Priority Data
Feb. 17, 2023 (KR) 10-2023-0021299

(51) Int. Cl. B32B 7/023; B32B 5/02; B32B 27/12

(52) U.S. Cl. CPC B32B 7/023; B32B 5/02; B32B 27/12; B32B 2250/05; B32B 2307/402; B32B 2307/536; B32B 2307/584; B32B 2307/7376

(57) ABSTRACT

Provided is a fabric comprising a plastic substrate with an upper protective film on one surface and a lower protective film on the opposite surface. A laminated fabric is obtained by laminating, on the one surface of the plastic substrate from which the upper protective film has been removed, an FG film composed of a pattern coating layer, a separately-prepared latent image pattern layer and a base film layer is laminated, and then irradiating same with ultraviolet rays. Furthermore, the latent image patterned-fabric, of which the FG film has been peeled off and removed from the laminated fabric such that the pattern coating layer is exposed at the surface, has crack resistance for a 3D-shaped part and scratch resistance of a high surface hardness of 3 H or higher during a 3D molding process in which a film of a plastic material is molded through heat and pressure after UV imprinting.

### TECHNICAL FIELD

The present invention relates to a laminated fabric having a glossy surface, a manufacturing method therefor, and an exterior cover product using a latent image-patterned fabric obtained therefrom. More particularly, the present invention relates to: a laminated fabric in which a fabric, composed of a plastic substrate with a upper protective film on one side and a lower protective film on the other, has a pattern coating layer and a separately prepared FG film composed of a latent pattern layer and a base film layer on one surface of the plastic substrate, from which the upper protective film has been removed, followed by ultraviolet irradiation. The FG film is then peeled off from the laminated fabric, exposing the pattern coating layer on the surface, to create a latent pattern-bearing fabric. This fabric, when used in a 3D forming process that shapes a plastic material film through UV imprinting followed by heat and pressure, exhibits crack resistance in 3D shaped parts (curved portion) and scratch resistance with a high surface hardness of 3 H or more. Consequently, it is useful as an exterior cover product for protecting the surfaces of mobile products, electronic products, home appliances, and automotive products.

### BACKGROUND ART

Cases made by injection molding of synthetic resins such as PC and ABS have been used for electronic devices such as mobile phones or communication devices. Such cases form the outer surface of the mobile phone, but there are limitations in creating diverse design expressions or in enhancing the surface gloss while creating design expressions.

Especially in the case of mobile products, mobile phones or tablet PCs include liquid crystal displays as information and communication display devices, making them susceptible to damage from drops or impacts. Accordingly, protective back covers are provided on the back, allowing for various decorations, such as company logos, letters, symbols, and design patterns.

In terms of materials, the cover panels used in early mobile phones were mainly plastic injection panels using PC resin, which have the advantages of being inexpensive and easy to manufacture, but have limitations in improving design or appearance and have the problem of being prone to scratches due to their nature and being vulnerable to strength, heat, etc.

In addition, metal panels such as aluminum and magnesium panels have also been used, but they are expensive and thick, and have the problem of interfering with the implementation of wireless communication performance.

The glass panel proposed for these problems has the advantage of making the design gorgeous and luxurious, but it has the disadvantage of being difficult to form in a 3D manner, resulting in high production cost and low productivity, and above all, being prone to breakage during processing or when used by the user.

In addition, the Glastic (PC-PMMA composite sheet) material combines high hardness and the ductility of PC material and has advantages in use, but has a disadvantage in that, when mass-producing this sheet, a large amount of fine dust is inevitably generated during the cutting process due to the high hardness of PMMA, resulting in an increase in the defect rate. In particular, there is a problem in that surface cracks occur during the forming (3D forming) process due to the high hardness of PMMA.

From the foregoing, even if the various substrate materials are applied, instability still occurs in terms of product reliability.

The cover shape corresponding to a conventional mobile phone case is formed by heated upper and lower molds. Since the high-temperature upper mold, which is heated to approximately 130 to 150° C., directly contacts and presses the film, the film often undergoes damage, such as distortion or tearing due to heat.

Accordingly, Patent Document 1 discloses a technology for preheating a film using a preheating member that is driven left and right without interfering with an upper mold and a lower mold, and then forming the film using the upper mold and the lower mold. However, this technology is not economical because a separate preheating member should be installed and a device for driving the preheating member and a device for heating the preheating member should also be installed.

Accordingly, Patent Document 2 discloses a film-forming apparatus including a lower mold on which a film is placed, a heating-type upper mold that forms the film into a cover shape together with the lower mold, an actuator that moves the upper mold up and down, a detection unit that detects whether the upper mold has been descended to a preheating position spaced apart from the lower mold, and a controller that controls the actuator so that the descending of the upper mold is temporarily stopped when the upper mold is at the preheating position, and discloses that the film-forming apparatus is economical and may shorten the process time, by using the original upper mold as a preheating means for applying heat to the upper side of the film. Furthermore, a concave rectangular forming groove defining the outer surface of the film is formed in the upper mold to form the film.

However, there are problems in that the film placed on the lower mold may flow from the placed position during forming, causing the film to warp, and it is only possible to form the film into a flat-shaped cover according to the shape of the forming groove, making it difficult to form various external appearances. In addition, there is a process of separating and removing the protective tape attached to the film before forming the film, and thus there is a problem in that the process time increases and additional process costs are incurred.

Patent document 3 proposes a film forming jig and a film-forming method, in which a film is formed into a curved back cover for a mobile phone without warping by compressing the upper part of the film and the end of the film using a double-structured upper mold.

In addition, Patent Document 4 relates to a method for manufacturing a back cover for a mobile communication device housing, and discloses that a special solution composition is applied to the attachment surface of a back cover-shaped upper film member, or special primer treatment is performed, or special primer treatment is performed after applying a special solution composition, thereby strongly attaching the upper film member to a lower film member having another pattern, thereby suppressing cracking and breaking when implementing a back cover shape. However, to overcome the problem of cracking during forming, a special primer or ink is used as a means for surface modification.

The above-described prior art documents propose a method for 3D forming in accordance with the increasing trend of applying 3D patterns in which the edges of the panel are processed into a curved shape to improve the three-dimensionality and grip of recent devices, but have not yet solved the problem of cracks in the curve-shaped edge portion.

It is an inevitable process in the injection molding process using plastic. In the case of the coating process after injection molding, pellets are formed and then placed on an injection mold and spray-coated to produce a product. In this case, the defect rate is high and the process is not free from environmental regulations due to waste liquid and volatile organic compounds (VOCs).

As another method, a 3D forming process after patterning is performed by applying a film of plastic material using a UV imprinting method, applying heat to the upper part, and applying a vacuum to the lower part. In this method, problems associated with surface reliability, especially cracks at the edges, occur.

As another injection molding method, a 3D forming process using a UV imprinting method is performed after patterning by providing heat and pressure to both the upper and lower parts. This method is also not free from the problem of edge cracks due to the energy of heat and pressure concentrated on the surface.

In general, in a thin film structure formed on a substrate for a specific purpose, residual stress exists within the thin film due to the accumulation of the stress generated during the formation of the thin film. If the size exceeds a certain level, a peeling phenomenon in which the thin film is peeled off occurs immediately after formation of the thin film or during the use of the thin film.

The causes of residual stress in the thin film include internal factors such as the presence of impurities during thin film formation and external factors such as the interaction between the thin film and the substrate, that is, tensile and compressive stress. When a crack occurs due to tensile stress, the thin film at the crack boundary may bend upward or wrinkles may occur due to compressive stress.

Accordingly, the present inventors have made efforts to solve the problems occurring in the prior art. As a result, the present inventors have performed a 3D forming process of forming a film of plastic material through heat and pressure after UV imprinting, and provided a laminated fabric having a glossy surface by preparing a film composed of an upper protective film on one surface of a plastic substrate and a lower protective film on the other surface of the plastic substrate, and laminating a pattern coating layer and a separately prepared FG film composed of a latent pattern layer and a base film layer on one surface of the plastic substrate, from which the upper protective film has been removed. Also, the present inventors have provided a latent image-patterned fabric having the pattern coating layer exposed on the surface by peeling off the FG film from the laminated fabric, and have found that the latent image-patterned fabric may prevent cracks in a 3D shape portion (edge portion) and may have a surface having a pencil hardness of 3H or higher and various patterns, thereby completing the present invention.
(Patent Document 1) Korean Patent No. 10-0767574 (published on Oct. 17, 2007)
(Patent Document 2) Korean Patent No. 0918029 (Published on Sep. 18, 2009)
(Patent Document 3) Korean Patent No. 2192308 (published on Dec. 17, 2020)
(Patent Document 4) Korean Patent Application Publication No. 2022-0163621 (published on Dec. 21, 2022)
(Non-Patent Document 1) Korean J. Met. Mater., Vol. 58, No. 3 (2020) pp.175-181, Effect of a Metal Thin Film's Residual Stress and Manufacturing Process on Thin Film Micro-Crack

### DISCLOSURE

### Technical Problem

An object of the present invention is to provide a laminated fabric having a glossy surface in which a pattern coating layer and a separately prepared FG film composed of a latent pattern layer and a base film layer are laminated on one surface of a plastic substrate, and a method for manufacturing the same.

Another object of the present invention is to provide a latent image-patterned fabric having the pattern coating layer exposed on the surface, obtained by peeling off the FG film from the laminated fabric.

Still another object of the present invention is to provide an external cover product including the latent image-patterned fabric, which is applicable to mobile products, electronic products, home appliances, and automobile products.

### Technical Solution

The present invention provides a laminated fabric having a glossy surface, in which a fabric, composed of a plastic substrate with a upper protective film on one side and a lower protective film on the other, has a pattern coating layer and a separately prepared FG film composed of a latent pattern layer and a base film layer on one surface of the plastic substrate, from which the upper protective film has been removed, followed by ultraviolet irradiation.

The pattern of the latent pattern layer may be transferred to the pattern coating layer by UV irradiation, wherein the pattern of the latent pattern layer may be any one selected from the group consisting of a matte texture with anti-glare treatment, a glossy texture, and a design.

The FG film of the present invention includes the latent pattern layer formed by curing a UV-curable resin composition on one surface of the base film layer by UV irradiation, wherein the UV irradiation is performed with an energy dose of 50 to 800 mJ.

Here, the base film layer is made of any one selected from the group consisting of PET, PC, PMMA, PVC, PE, and ABS.

It is preferable that the thickness of the latent pattern layer of the FG film is 5 to 70 um and the thickness of the base film layer of the FG film is 0.02 to 0.5 mm.

In addition, the UV-curable resin composition for forming the latent pattern layer of the FG film preferably further contains silicone and fluorine to ensure slipperiness after curing.

The present invention also provides a method for manufacturing a laminated fabric having a glossy surface.

Specifically, the method comprises: a step of preparing a film composed of an upper protective film on one surface of a plastic substrate and a lower protective film on the other surface of the plastic substrate;
a step of removing the upper protective film;
a step of applying an FG coating layer solution to the one surface from which the upper protective film has been removed;
a step of manufacturing an FG film composed of an FG latent pattern layer and an FG base film layer; and
a step of laminating so that the latent pattern layer of the said fabricated FG film and the said coating layer solution-applied surface face each other, followed by a UV irradiation process.

The UV irradiation following the lamination is performed at 100 to 1,000 mJ.

The present invention also provides a latent image-patterned fabric having the pattern coating layer exposed on the surface, obtained by peeling off the FG film composed of the latent pattern layer and the base film layer from the laminated fabric having the glossy surface.

Here, the release force of the FG film including the latent pattern layer is preferably 2 to 250 gf/25 mm, and a pattern with a roughness (Rz) of 70 μm or less is formed on the pattern coating layer by transfer. Specifically, the pattern of the latent pattern layer of the FG film, which is any one pattern selected from the group consisting of a matte texture with anti-glare treatment, a glossy texture, and a design, is transferred to the pattern coating layer.

The latent image-patterned fabric of the present invention may be surface-modified by additional UV irradiation of the pattern coating layer with a UV energy dose of 300 to 1,500 mJ, and the pencil hardness of the pattern coating layer satisfies 3 H to 7 H.

In addition, the thickness of the pattern coating layer is 5 to 50 μm, and the pattern coating layer may be colored by adding a pigment or dye.

The present invention also provides an external cover product having scratch resistance and crack resistance including the latent image-patterned fabric.

The external cover product may be applied to any one selected from the group consisting of mobile products, electronic products, home appliances, and automobile products.

### Advantageous Effects

The present invention may provide a laminated fabric having a glossy surface, which may prevent cracks in a 3D-shape portion (edge portion), have a high surface hardness of 3 H or higher, ensure durability, and have various patterns or designs, and a latent image-patterned fabric obtained by peeling off a portion of the laminated fabric.

The latent image-patterned fabric of the present invention has crack resistance and a scratch resistance corresponding to a high surface hardness of 3 H or higher for a 3D-shape portion (curved portion) during a 3D forming process of forming a film of plastic material under heat and pressure after UV imprinting, and thus may be used as an external cover product for protecting the surface of mobile products including mobile phones or tablet PCs, electronic products, home appliances, and automobile products.

Therefore, the latent image-patterned fabric of the present invention has a high surface hardness in a 3D shape, has no cracks in a 3D-shape portion (edge portion), has durability that was limited in products produced by conventional plastic injection processes and in glass panels, and may present various design patterns.

### BRIEF DESCRIPTION OF DRAWINGS

FIG. 1 is a cross-sectional schematic view of a conventional film structure for surface protection of a product.

FIG. 2 is a cross-sectional schematic view of a laminated fabric according to a first embodiment of the present invention.

FIG. 3 is a cross-sectional schematic view showing the separated main components of the laminated fabric shown in FIG. 2.

FIG. 4 is a cross-sectional schematic view of a laminated fabric according to a second embodiment of the present invention.

FIG. 5 is a cross-sectional schematic view showing the separated main components of the laminated fabric shown in FIG. 4.

FIG. 6 is a flow chart of a method for manufacturing the laminated fabric of the present invention.

FIG. 7 is a flow chart of a method for manufacturing a latent image-patterned fabric from a laminated fabric of the present invention.

FIG. 8 shows an example of a pattern of a pattern coating layer before and after removing an FG film from a laminated fabric of the present invention.

FIG. 9 shows another example of a pattern on the a pattern coating layer before and after removing an FG film from a laminated fabric of the present invention.

FIG. 10 is a photograph of an example of a pattern created on a curved portion of an external cover product for surface protection of a mobile phone, which includes a latent image-patterned fabric of the present invention.

FIG. 11 is a photograph of another example of a pattern created on a curved portion of an external cover product for surface protection of a mobile phone, which includes a latent image-patterned fabric of the present invention.

### BEST MODE

Hereinafter, the present invention will be described in detail.

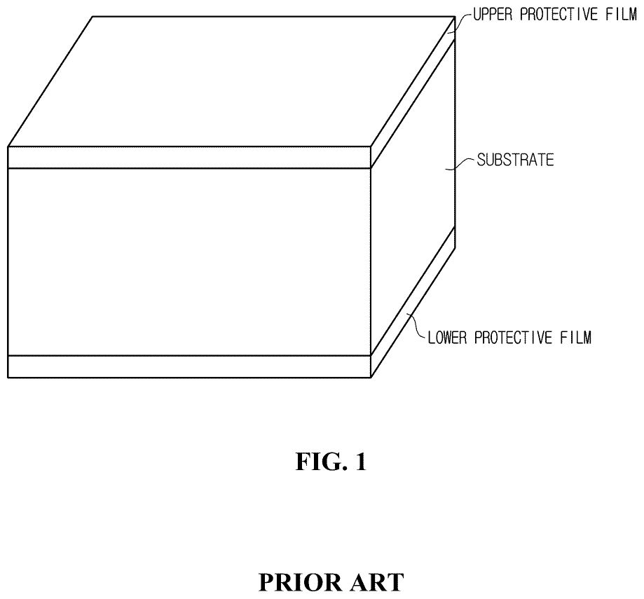

FIG. 1 is a cross-sectional schematic view of a conventional fabric structure for product surface protection, where a PE or PET series adhesive is applied to protect a plastic substrate. and the fabric structure is composed of an upper protective film on one surface and a lower protective film on the other surface of the plastic substrate.

Conventional fabric is effective in preventing scratches on the surface of plastic substrates, but cracks are unavoidable in the process of bending the product shape by performing a 3D forming process of forming a film of plastic material under heat and pressure after UV imprinting.

Specifically, a multilayer structure film formed on the front or rear surface of a plastic substrate undergoes cracks, displacement, or delamination due to the weakening of the bonding strength of the multilayer structure by heat or pressure applied during a 3D forming process due to interfacial stress occurring at the interlayer boundary between different materials.

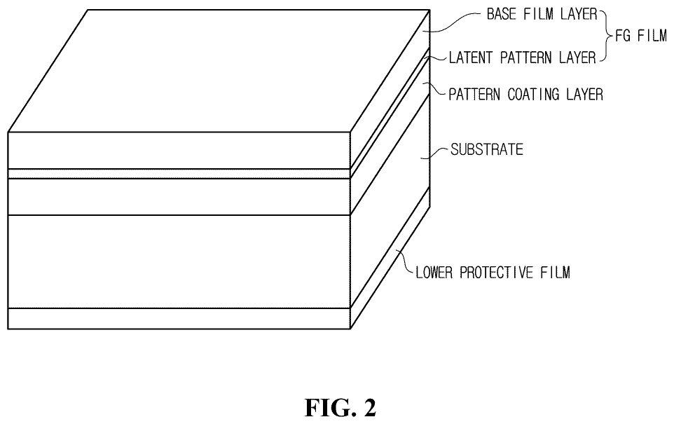

FIG. 2 is a cross-sectional schematic view of a laminated fabric according to a first embodiment of the present invention. The present invention provides a laminated fabric having a glossy surface,
manufactured by preparing a film composed of an upper protective film on one surface of a plastic substrate and a lower protective film on the other surface of the plastic substrate, and
laminating a pattern coating layer and a separately prepared FG film composed of a latent pattern layer and a base film layer on one surface of the plastic substrate, from which the upper protective film has been removed, followed by sufficient squeezing and UV irradiation.

The substrate used in the present invention is glass; or a plastic material capable of injection molding and extrusion, which is any one material selected from the group consisting of PET, PC, PMMA, PVC, PE, and ABS.

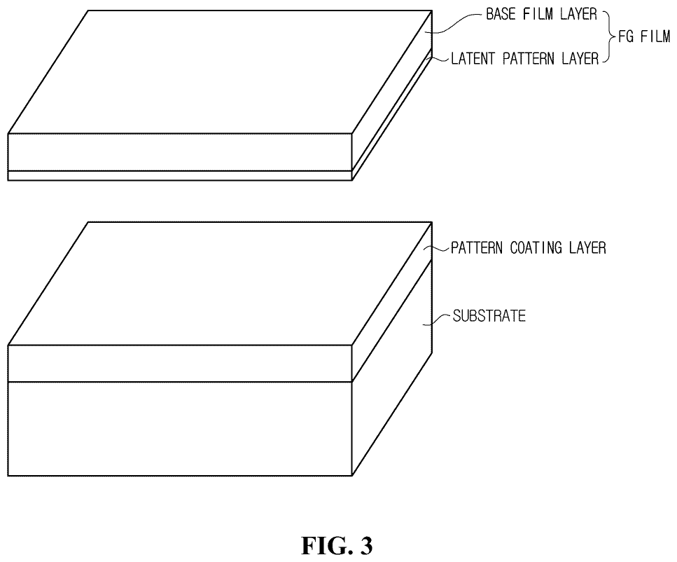

FIG. 3 is a cross-sectional schematic view showing the separated main components of the laminated fabric shown in FIG. 2. A separately prepared FG film is placed on the pattern coating layer formed on the plastic substrate.

The FG (Flex Glastic) film includes a latent pattern layer formed on one surface of a base film layer by curing a UV-curable resin composition by UV irradiation, and is referred to as “FG film” throughout the present specification.

In the FG film, the base film layer is any one selected from the group consisting of PET, PC, PMMA, PVC, PE and ABS. More preferably, PET having heat resistance and shrinkage resistance is used.

The latent pattern layer is formed by curing a UV-curable resin composition on the base film layer by UV irradiation, wherein the UV irradiation for curing is performed with a UV energy dose of 50 to 800 mJ.

It is preferable that the thickness of the latent pattern layer of the FG film is 5 to 70 μm and the thickness of the base film layer is 0.02 to 0.5 mm.

To manufacture the laminated fabric of the present invention, a thickness (t_{f2}) of the FG film is laminated on a thickness (t_{f1}) of the pattern coating layer formed on the plastic substrate, and then first UV irradiation is performed, thereby alleviating the concentration of residual stress (σ) in the substrate.

The design to alleviate the concentration of residual stress (σ) by controlling the thickness to a large thickness is supported by the inverse relationship between the film thickness (h_{f}) and stress (σ) in the equation below [Non-Patent Document 1]. More specifically, Non-Patent Document 1 reports that, as a result of evaluating the residual stress of a thin film, the residual tensile stress decreases rapidly as the thickness of the deposited film increases, indicating that the control of the residual stress of the thin film is highly correlated with the deposition thickness.

Therefore, based on the result that the residual tensile stress decreases as the thickness (h_{f}) of the deposited film increases, the laminated fabric of the present invention may be designed such that the thickness (t_{f2}) of the FG film is added to the thickness (t_{f1}) of the pattern coating layer formed on the plastic substrate, thereby alleviating the concentration of residual stress (σ) in the substrate.

$$σ = \frac{Es \times hs \text{?}}{6 hf ( 1 \times Vs ) R}$$

$$\text{?} \text{indicates text missing or illegible when filed}$$

wherein σ is stress, Eₛ is the Young's modulus of the substrate, hₛ is the substrate thickness, hf is the film thickness, Vₛ is Poisson's ratio, and R is radius of curvature. Here, the substrate thickness (hₛ) is the thickness of the plastic substrate.

The laminated fabric having a glossy surface according to the present invention is one in which the pattern of the latent pattern layer formed on the base film layer is transferred to the laminated pattern coating layer by UV irradiation.

In this case, the pattern in the present invention includes designs such as prisms, hemispheres, triangles, squares, polygons, dots, and designed logos, as well as matte texture with anti-glare treatment or glossy textures.

Specifically, the pattern coating layer in the laminated fabric of FIG. 2 and FIG. 3 shows a pattern where a matte (anti-glare) or glossy texture is transferred and implemented.

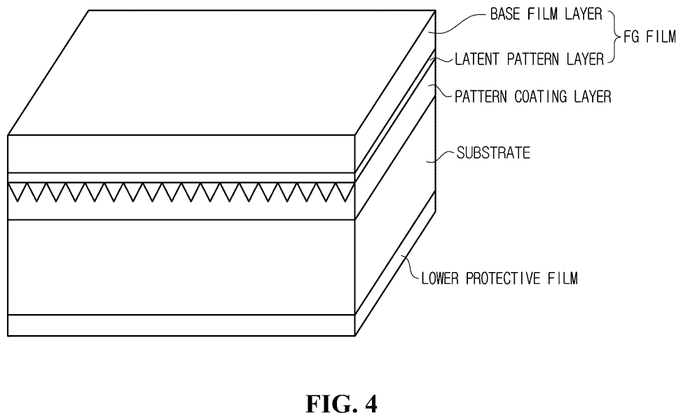

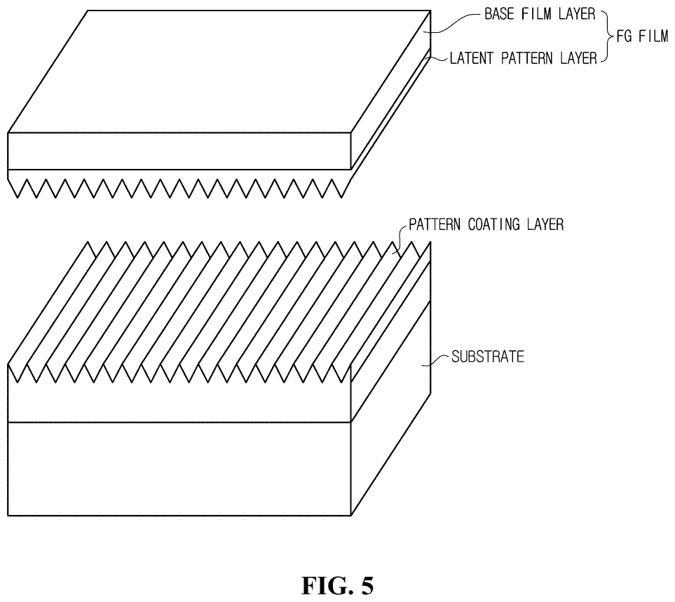

FIG. 4 is a cross-sectional schematic view of a laminated fabric according to a second embodiment of the present invention, and FIG. 5 is a cross-sectional schematic view showing the separated main components of the laminated fabric shown in FIG. 4.

Here, the description of each component to be laminated in the second embodiment is the same as in the first embodiment, but an example in which the pattern of the pattern coating layer is a prism pattern is presented, but the pattern is not limited to the prism pattern.

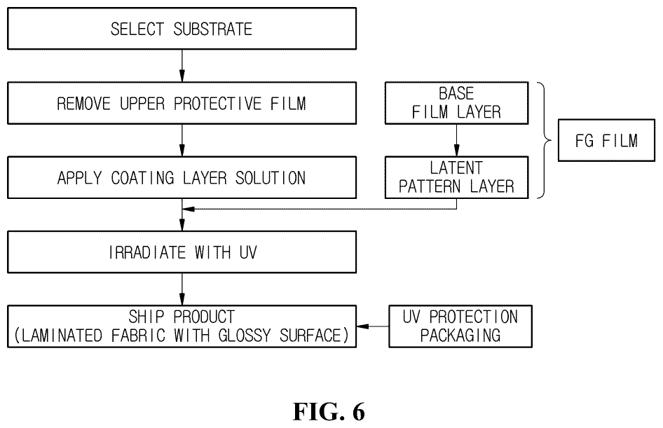

FIG. 6 is a flow chart of a method for manufacturing the laminated fabric of the present invention. Specifically, the method comprises: a step of preparing a film composed of an upper protective film on one surface of a plastic substrate and a lower protective film on the other surface of the plastic substrate;
a step of removing the upper protective film;
a step of applying an FG coating layer solution to the one surface from which the upper protective film has been removed;
a step of manufacturing an FG film composed of a latent pattern layer and a base film layer; and
a step of laminating so that the latent pattern layer of the said fabricated FG film and the said coating layer solution-applied surface face each other, followed by a UV irradiation process.

In the method for manufacturing a laminated fabric having a glossy surface according to the present invention, the coating layer solution applied onto the substrate is a liquid UV-curable resin composition in which a monomer or an oligomer is polymerized and cured into a polymer by irradiation with UV light at a wavelength of 254 nm or 365 nm.

In general, products obtained by a UV-curing method, which includes printing or coating using UV light, are completed by UV-curing for a very short time rather than heat as a curing means, and thus low-temperature curing is possible. In addition, they have excellent surface hardness, surface gloss, and electrical insulation properties compared to heat-dried products in, and their productivity is several or dozens of times higher, and thus their added value is also higher. In particular, the products obtained by the UV-curing method have the advantage of having a surface hardness strong enough to resist scratches from fingernails or everyday tools.

It is preferable that the coating layer solution of the present invention be formed so that the thickness of the coating layer formed by UV irradiation following lamination is 5 to 50 μm. Here, if the thickness is less than 5 μm, it is insufficient for realizing various patterns, and a thickness of more than 50 μm is preferable for pattern transfer, but there is a problem that the thickness increases excessively and the process time becomes longer.

In addition, the UV irradiation following lamination is performed at 100 to 1,000 mJ, more preferably 300 to 600 mJ.

In the method for manufacturing a laminated fabric having a glossy surface according to the present invention, the separately prepared FG film is formed by curing an UV-curable resin composition on the base film layer by UV irradiation to form a latent pattern layer, wherein the UV irradiation for curing is performed with a UV energy dose of 50 to 800 mJ.

The UV-curable resin composition has at least one (meth) acrylate functional group in one molecule, and is a solvent-free UV-curable liquid. In addition, it is cured by UV irradiation, and thus is environmentally friendly because the odor problem caused by solvent volatilization is fundamentally prevented.

More specifically, the UV-curable resin composition contains: a) 40 to 90 wt % of a monomer and oligomer having at least three (meth) acrylate functional groups in one molecule; b) 0 to 20 wt % of an oligomer; c) 5 to 25 wt % of a UV-reactive diluent; d) 2 to 15 wt % of a photopolymerization initiator; and e) 0 to 3 wt % of an additive.

Here, a) the monomer and oligomer having at least three (meth)acrylate functional groups in one molecule is the main component of the UV-curable resin composition, which determines the curing rate and the mechanical and chemical properties of the cured coating layer. Specific examples thereof include UV-curable compounds having three or more functional groups, including acrylate monomers such as dipentaerythritol penta(meth)acrylate, dipentaerythritol hexa(meth)acrylate, xylitol penta(meth)acrylate, and glyceryl dipentaerythritol hepta(meth)acrylate, and a urethane(meth)acrylate oligomer or a polyester(meth)acrylate oligomer.

The urethane(meth)acrylate oligomer contains, as a repeating unit, a urethane bond produced by an addition reaction between a hydroxyl group and an isocyanate group, and a cured product thereof is generally excellent in hardness, flexibility, adhesion, and low-temperature properties, and is thus used in a wide range of fields. The polyester(meth)acrylate oligomer has low viscosity and excellent weather resistance properties.

The multifunctional UV-curable compounds may be used alone or in combination of two or more.

The preferred content of the component (a) is 40 to 90 wt %, preferably 60 to 80 wt %, based on the total weight of the composition. If the content is less than 40 wt %, the curing rate becomes slow and the surface hardness and wear resistance of the final cured coating layer are reduced. In addition, if the content is more than 90 wt %, the curing rate increases, but the flexibility of the cured coating layer decreases, making it prone to cracking.

In the above, b) the oligomer is used to improve the flexibility of the cured coating layer and adhesion thereof to the substrate, and representative examples thereof include epoxy (meth)acrylate, polyether (meth)acrylate, polyester (meth)acrylate, and urethane (meth)acrylate. In the present invention, an aliphatic urethane (meth)acrylate oligomer having two functional groups is preferably used because it does not yellow, has excellent durability, and improves the flexibility of the cured coating layer. The preferred content of the component b) is 0 to 20 wt % based on the total weight of the composition. If the content is more than 20 wt %, the flexibility increases, but the viscosity of the composition increases, the curing rate becomes slow, and the surface hardness and wear resistance of the final cured coating layer are reduced.

In addition, c) the UV-reactive diluent is mainly a monomer having a molecular weight of 1,000 or less, and is used for the purpose of lowering the viscosity of the UV-curable composition, increasing adhesion to the substrate, and also increasing the flexibility of the cured coating layer.

The UV-reactive diluent exhibit the following differences in properties depending on the number of functional groups contained in one molecule. Monofunctional monomers improve adhesion to the substrate and flexibility, but have low reactivity, and thus when they are used in excessive amounts, uncuring may occur. Bifunctional monomers are commonly used mainly because they have appropriate viscosity, reactivity, and flexibility, and trifunctional or tetrafunctional monomers have good reactivity and high crosslinking density after curing, which can increase the surface hardness, but have the disadvantage of low flexibility. In order to increase the reactivity and crosslinking density within a range that does not impair the flexibility, it is preferable to use the above-described monomers in combination.

Specific examples of UV-reactive diluents that may be used in the present invention include 2-hydroxyethyl(meth)acrylate, 2-hydroxypropyl(meth)acrylate, diethylene glycol mono(meth)acrylate, polyethylene glycol mono(meth)acrylate, polypropylene glycol mono(meth)acrylate, isobornyl(meth)acrylate, ethylene glycol di(meth)acrylate, 1,3-propylene glycol di(meth) crylate, 1,4-butanediol di(meth)acrylate, 1,6-hexanediol di(meth)acrylate, (tri, tetra or poly)ethylene glycol di(meth)acrylate, tripropylene glycol di(meth)acrylate, ethoxylated bisphenol A di(meth)acrylate, trimethylolpropane tri(meth)acrylate, pentaerythritol (tri or tetra)(meth)acrylate, and pentaglycerol tri(meth)acrylate.

The preferred content of the component c) is 5 to 25 wt % based on the total weight of the composition for forming the coating layer, excluding the non-reactive solvent. If the content of the UV-reactive diluent is less than 5 wt %, the dilution effect is almost non-existent, and thus problems due to high viscosity may occur and the flexibility of the cured coating layer may be reduced. In addition, if the content of the UV-reactive diluent is more than 25 wt %, the curing rate becomes slow, making it impossible to obtain a complete coating layer, and the surface hardness and wear resistance of the cured coating layer may be reduced.

In the UV-curable resin composition of the present invention, d) the photopolymerization initiator acts to initiate a reaction by absorbing UV light and generating free radicals. In the present invention, a low-yellowing type α-hydroxyalkylphenone compound is preferably used for improving reactivity, and specific examples thereof include 1-hydroxy-cyclohexyl-phenyl ketone, α,α-dimethoxy-α-hydroxy acetophenone, and 1-[4-(2-hydroxyethoxy) phenyl]-2-hydroxy-2-methyl-1-propan-1-one, which are used alone or in combination of two or more.

The preferred content of the component d) is 2 to 15 wt %, preferably 5 to 10 wt %, based on the total weight of the composition. If the content of the photopolymerization initiator is less than 2 wt %, the curing rate becomes slow and the reaction rate also decreases, making it impossible to obtain a complete coating layer. If the content is 15 wt %, the reactivity increases during use, but there is a problem in that the surface hardness is reduced.

It is preferable that the UV-curable resin composition that is used for the latent pattern layer of the FG film of the present invention further contains silicone and fluorine to ensure slipperiness after curing. In this case, the release force of the FG film including the latent pattern layer is adjusted to 2 to 250 gf/25 mm.

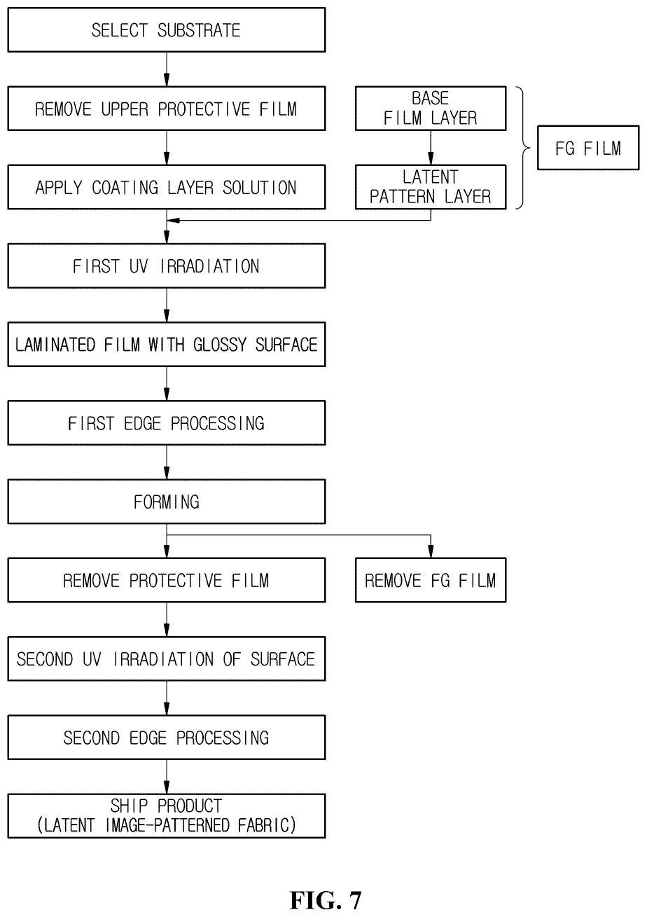

FIG. 7 is a flow chart of a method for manufacturing a latent image-patterned fabric from the laminated fabric of the present invention, which involves a first edge processing step of the laminated fabric with a glossy surface manufactured according to the process of FIG. 6, a forming process following the edge processing,
a process of peeling off the FG film composed of the latent pattern layer and the base film layer following the forming process; and
after the peeling-off process, a process of subjecting the pattern coating layer exposed on the surface to second UV irradiation, followed by second edge processing, thereby manufacturing a latent image-patterned fabric as a final product.

According to the present invention, a forming (3D molding) process of forming a film of a plastic material under heat and pressure is performed after UV imprinting, and by controlling residual stress at the interlayer interface, the reliability of the material may be improved, and in particular, cracks in a 3D-shape portion (curved portion) may be prevented. Accordingly, the present invention may be applied to a 3D pattern in which the edge of the panel is processed into a curved shape to improve the three-dimensionality and grip of recent devices.

To manufacture the latent image-patterned fabric of the present invention, for second UV irradiation of the pattern coating layer exposed on the surface, the pattern coating layer is irradiated with UV light with an energy dose of 300 to 1,500 mJ, preferably 300 to 1,000 mJ, to achieve complete curing and enhance the surface hardness.

Through a method of measuring the pencil hardness of the pattern coating layer (a method of using a Mitsubishi hi-uni pencil and scratching 10 mm at a 45° angle with a load of 1 kg and a speed of 3 mm/sec), it can be confirmed that the pencil hardness is 3 H to 7 H, indicating that the surface has strong scratch resistance.

In addition, the pattern coating layer of the present invention may be colored by adding a pigment or dye.

The present invention also provides a latent image-patterned fabric obtained by the above-described manufacturing method.

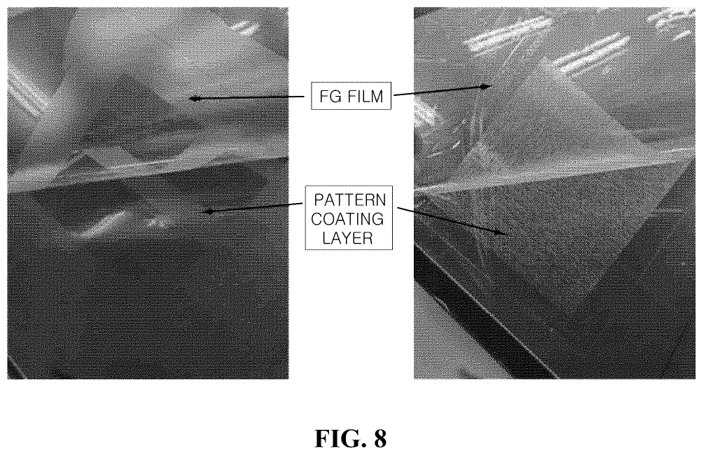

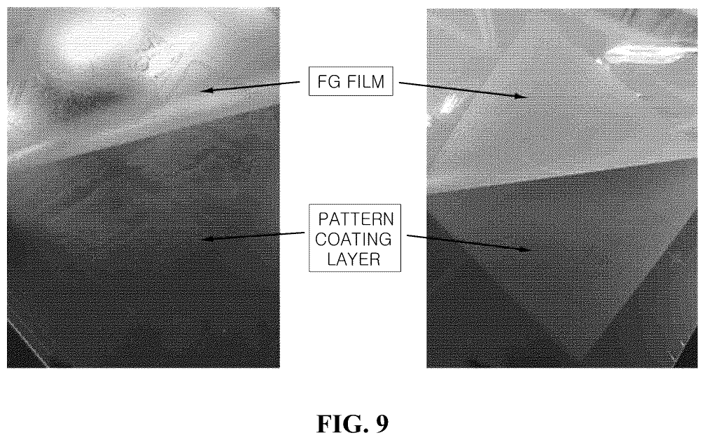

FIGS. 8 and 9 show an example of a pattern transferred to the pattern coating layer before and after removing the FG film from the laminated fabric of the present invention. In the case of FIG. 8, on the pattern coating layer where a part of the FG film was peeled off from the laminated fabric with a glossy surface, the design (squares, left) and the surface-treated matte pattern (right) of the latent pattern layer of the FG film can be confirmed.

In addition, as shown in FIG. 9, it can be confirmed that a pattern (design pattern, left) of the latent pattern layer of the FG film and a matte (anti-glare) textured pattern (right) are exposed on the surface of the pattern coating layer.

Therefore, it can be confirmed that the latent image-patterned fabric of the present invention includes the pattern coating layer having a pattern smoothly transferred from the pattern of the latent pattern layer of the FG film. Here, the pattern has a roughness (Rz) of 70 μm or less, and specifically, various designs including prisms, hemispheres, triangles, squares, polygons, dots, and designed logos, as well as matte (anti-glare) or glossy texture patterns, can be implemented.

The above-described latent image-patterned fabric combines the advantages of plastic and glass materials, is free of cracks in 3D shaped parts, thus enabling the implementation of curved surfaces without cracks, has excellent scratch resistance with a pencil hardness of 3 H to 7 H, and allows for the expression of design patterns on the surface and curved parts.

Therefore, the present invention provides an external cover product having scratch resistance and crack resistance including the above-described latent image-patterned fabric.

The external cover product may be applied to any product group that requires gloss and is subjected to curved surface forming, and for example, it will be useful for surface protection of mobile products including mobile phones and tablet PCs, electronic products, home appliances including electric rice cookers, electric cooktops, and refrigerators, and automobile exteriors.

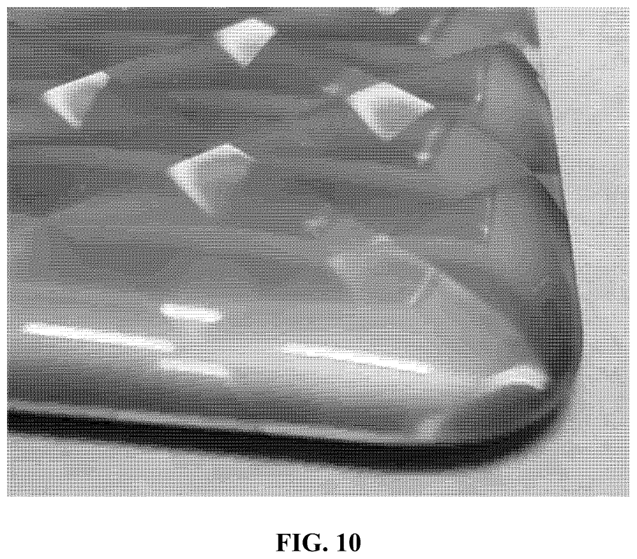

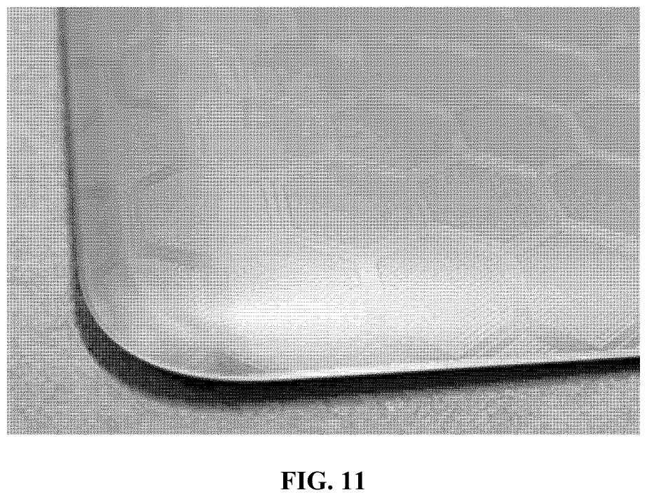

FIGS. 10 and 11 are photographs of an example of a pattern created on a curved portion of an external cover product for surface protection of a mobile phone, which includes the latent image-patterned fabric of the present invention. It can be confirmed that various patterns are created not only on the surface but also on the curved portion.

Therefore, the external cover product for protecting the surface of a mobile phone, which includes the latent image-patterned fabric of the present invention, satisfies excellent surface properties, and in particular, may improve the surface texture of the product, thereby increasing consumer preference.

Although the present invention has been described in detail only with respect to the described embodiments, it will be apparent to those skilled in the art that various modifications and variations are possible without departing from the technical scope of the present invention, and it is natural that such modifications and variations fall within the scope of the appended claims.

What is claimed is:

1. A laminated fabric having a glossy surface, characterized in that, in a fabric comprising
a plastic substrate with a upper protective film on one surface and a lower protective film on the other surface,
on the one surface of the plastic substrate from which the said upper protective film has been removed,
a pattern coating layer and
a separately prepared FG film, comprising a latent pattern layer and a base film layer, are laminated and then ultraviolet-irradiated.

2. The laminated fabric of claim 1, wherein a pattern of the latent pattern layer is transferred to the pattern coating layer by UV irradiation.

3. The laminated fabric of claim 1, wherein a pattern of the latent pattern layer is any one selected from the group consisting of a matte texture with anti-glare treatment, a glossy texture, and a design.

4. The laminated fabric of claim 1, wherein the FG film is comprised of a latent pattern layer formed by curing a UV-curable resin composition on one surface of a base film layer by UV irradiation.

5. The laminated fabric of claim 4, wherein the UV irradiation is performed with an energy dose of 50 to 800 mJ.

6. The laminated fabric of claim 4, wherein the base film layer base film layer is made of any one selected from the group consisting of PET, PC, PMMA, PVC, PE, and ABS.

7. The laminated fabric of claim 4, wherein the latent pattern layer of the FG film has a thickness of 5 to 70 μm, and the base film layer base film layer of the FG film has a thickness of 0.02 to 0.5 mm.

8. The laminated fabric of claim 4, wherein the latent pattern layer contains additional silicone and fluorine in the UV-curable resin composition, ensuring slip properties after curing.

9. A method for manufacturing a laminated fabric having a glossy surface, comprising the steps of:
preparing a fabric composed of a plastic substrate with a upper protective film on one surface and a bottom protective film on the other surface;
removing the upper protective film;
applying a coating layer solution onto the said removed surface;
fabricating an FG film composed of a latent pattern layer and a base film layer; and
laminating so that the latent pattern layer of the said fabricated FG film and the said coating layer solution-applied surface face each other, followed by a UV irradiation process.

10. The method of claim 9, wherein the UV irradiation after lamination is performed at 100 to 1,000 mJ.

11. A latent image-patterned fabric, wherein the FG film, comprising a latent pattern layer and a base film layer, is peeled off and removed from the laminated fabric with a glossy surface of claim 1, thereby exposing the pattern coating layer on the surface.

12. The latent image-patterned fabric of claim 11, wherein a release force of the FG film comprising the latent pattern layer is 2 to 250 gf/25 mm.

13. The latent image-patterned fabric of claim 11, wherein the pattern coating layer has a thickness of 5 to 50 μm.

14. The latent image-patterned fabric of claim 11, wherein the pattern coating layer is further irradiated with UV light with an energy dose of 300 to 1,500 mJ.

15. The latent image-patterned fabric of claim 11, wherein the pattern coating layer has a pencil hardness of 3 H to 7 H.

16. The latent image-patterned fabric of claim 11, wherein the pattern coating layer has any one pattern selected from the group consisting of a matte texture with anti-glare treatment, a glossy texture, and a design.

17. The latent image-patterned fabric of claim 11, wherein the pattern coating layer is colored by adding a pigment or dye.

18. An external cover product having scratch resistance and crack resistance, comprising the latent image-patterned fabric of claim 11.

19. The external cover product of claim 18, which is applied to any one selected from the group consisting of mobile products, electronic products, home appliances, and automobile products.
